(19) United States
(12) Patent Application Publication
(10) Pub. No.: US 2016/0299733 A1
(43) Pub. Date: Oct. 13, 2016

(54) SYSTEM AND A METHOD FOR PRODUCING A SEAMLESS INFOGRAPHIC ON THE SCREENS OF ADJACENTLY PLACED PLURALITY OF HANDHELD ELECTRONIC DEVICES

(71) Applicant: ALGOSCENT, JERUSALEM (IL)

(72) Inventors: Dov YOSELIS, GEVA BNIYMIN (IL); Marshall TOMER, RACHELIM (IL)

(73) Assignee: ALGOSCENT, JERUSALEM (IL)

(21) Appl. No.: 15/096,604

(22) Filed: Apr. 12, 2016

Related U.S. Application Data
(60) Provisional application No. 62/146,425, filed on Apr. 13, 2015.

(51) Int. Cl. G06F 3/14; G06F 3/0488; G06T 11/20; G09G 5/12; G09G 5/14

(52) U.S. Cl. CPC G06F 3/1446; G09G 5/12; G09G 5/14; G06T 11/206; G06F 3/04883; G09G 2300/026; G09G 2370/16

(57) ABSTRACT

A method and a system are disclosed for producing a seamless infographic on a plurality of display units of a plurality of adjacent handheld electronic devices. The method includes the steps of receiving and storing data associated with a user in a handheld electronic device, processing at least a portion of the stored data from the handheld electronic device, then generating at least a portion of one or more infographics on a user interface based on at least a portion of the processed data, establishing a near-field communication between a plurality of adjacently placed handheld electronic devices to form a shared user interface, and manipulating the user interface to integrate a portion of at least two infographics from at least two handheld electronic devices to create at least one integrated seamless infographic on the shared user interface.

### BACKGROUND OF THE INVENTION

1. Field of the Invention

The present invention generally relates to a method and a system for producing a seamless infographic, and more particularly relates to a method and a system for producing a seamless infographic related to stored personal data on a plurality of display units of an adjacently placed plurality of handheld electronic devices.

2. Description of Related Art

In recent years, the processing and communication capabilities of mobile devices have been greatly improvised and thereby have enabled mobile devices to communicate using multiple types of transceivers, networks, and protocols. Mobile devices have become the computing device of choice for today's tech-savvy and on-the-go users.

As the technology has advanced, the processing and communication capabilities of mobile devices have tremendously improved, which has led such devices to increasingly be used to retrieve, access, create, and transmit content. Particularly, content is shared from one mobile device to another mobile device, or with a group of mobile devices indirectly using email and web-based sharing.

However, service providers and device manufacturers face significant technical challenges to support file sharing and related interactions among multiple mobile devices. Recently, at least some mobile devices have been configured for direct communication with other properly equipped mobile devices and devices using near field communication (NFC) technology. NFC is a technology that enables sharing content between two mobile devices and other devices to establish radio communication with each other by touching them together or bringing them into close proximity (e.g., within a few centimeters).

Typical mobile devices such as cell phones and the like are designed primarily for mobility and are small enough to fit into a pocket. Consequently, they feature small visual displays that are intended primarily for enabling a single user to view a limited amount of information at a time.

With the increase in social networking, shared computing, media file sharing and other tasks requiring interaction among several users concurrently, limited visual capacity and collaborative capability among devices inhibits the overall user experience. So, the viewing experience may be degraded due to the small the size of the display of the mobile device.

In recent decades the use of infographics has increased in both the consumer and corporate domains. There is a challenge of no known systematic, repeatable solutions for those seeking to work with collections of infographics that collectively represent more than one individual or subject area.

Accordingly, there is a need for a method and a system for enabling sharing of content using near field communication on multiple handheld electronic devices of a plurality of users. Further, there is a need to provide a system and a method of producing a seamless infographic on a plurality of display units of a plurality of adjacently placed handheld electronic devices for viewing by many users at the same time, in response to a user input.

### SUMMARY OF THE INVENTION

In accordance with the teachings of the present invention, there is provided a system and a method for producing a seamless infographic, based on personal data and a personality, on a plurality of display units of an adjacently placed plurality of handheld electronic devices.

An object of the present invention is to provide the method for producing seamless infographic. The method includes the steps of receiving and storing data associated with a user in a handheld electronic device; processing at least a portion of the stored data from the handheld electronic device; generating at least a portion of one or more infographics on a user interface based on at least a portion of the processed data; establishing a near-field communication between a plurality of adjacently placed handheld electronic devices to form a shared user interface; and manipulating the user interface to integrate a portion of at least two infographics from at least two handheld electronic devices to create at least one integrated seamless infographic on the shared user interface.

Another object of the present invention is the above method with an additional step of manipulating the user interface based on, at least in part, a command, a movement, or a combination thereof associated with the plurality of handheld electronic devices.

In another object of the present invention, the command is a gesture captured by at least one of the handheld electronic device.

In another object of the present invention the stored data is one or more of personal data, team strength, and a digital personality in the handheld electronic device.

Another object of the present invention is the above method, wherein the stored data is a digital personality comprising one or more of a skills graph, effectiveness graph, test success via running, and daily walked.

Another object of the present invention is the above method wherein the at least one infographic includes one or more of text elements and graphic elements.

Another object of the present invention is the above method wherein the near field communication is established via data tags.

Another object of the present invention is the above method, wherein the data tags are one or more of tickets, information signs or placards, security passes, currency, and storage devices containing data formatted to a data tag specification.

Another object of the present invention is the above method, wherein a protocol of the near field communication is Wi-Fi, Bluetooth, or a combination of Wi-Fi and Bluetooth.

Another object of the present invention is the above method, wherein the infographics and seamless infographic are selected from one or more of index charts, stacked graphs, small multiples, horizon graphs, histograms, box-and-whisker plots, maps, a force-directed layout, arc diagrams, personal information, and a matrix view.

An object of the present invention is to provide the system for producing a seamless infographic on a plurality of display units of a plurality of adjacent handheld electronic devices, comprising:

a plurality of adjacent handheld electronic devices, each of the devices containing a display;

at least one non-transitory computer readable medium, contained in at least one of the handheld electronic devices, configured to store data associated with a user;

at least one processor, contained in at least one of the handheld electronic devices, configured to receive and process the data;

at least one user interface contained on at least one of the displays, configured to display at least a portion of the data as an infographic;

a near-field communication between the plurality of handheld electronic devices, shared user interface contained on at least two of the displays, using the near-field communication,

wherein the at least user interface is further configured to be manipulable to integrate a portion of at least two infographics from at least least two handheld electronic devices to create at least one integrated seamless infographic on the shared user interface.

Another object of the present invention is the above system, further configured to manipulate the user interface based on, at least in part, a command, a movement, or a combination thereof associated with the plurality of handheld electronic devices.

Another object of the present invention is the above system, wherein the command is a gesture captured by at least one of the handheld electronic devices.

Another object of the present invention is the above system, wherein the stored data is one or more of personal data, team strength, and a digital personality in the handheld electronic device.

Another object of the present invention is the above system, wherein the stored data is a digital personality comprising one or more of a skills graph, effectiveness graph, test success via running, and daily walked.

Another object of the present invention is the above system, wherein the at least one infographic includes one or more of text elements and graphic elements.

Another object of the present invention is the above system, wherein the near field communication is established via data tags.

Another object of the present invention is the above system, wherein the data tags are one or more of tickets, information signs or placards, security passes, currency, and storage devices containing data formatted to a data tag specification.

Another object of the present invention is the above system, wherein a protocol of the near field communication is Wi-Fi, Bluetooth, or a combination of Wi-Fi and Bluetooth.

Another object of the present invention is the above system, wherein the infographics and seamless infographic are selected from one or more of index charts, stacked graphs, small multiples, horizon graphs, histograms, box-and-whisker plots, maps, a force-directed layout, arc diagrams, personal information and a matrix view.

These and other objects, features and advantages of the invention will become more fully apparent in the following detailed description, taken in conjunction with the accompanying drawings.

### BRIEF DESCRIPTION OF THE DRAWINGS

FIG. 1 illustrates a flowchart of a method for producing a seamless infographic on a plurality of display units of plurality of adjacently placed handheld electronic devices, in accordance with a preferred embodiment of the present invention;

FIG. 2 illustrates a screenshot on a handheld electronic device showing, by way of an example, a display a digital personality of a user, in accordance with an exemplary embodiment of the present invention;

FIG. 3 illustrates a screenshot showing, by way of an example, a swipe gesture for connecting the displays of a plurality of adjacently placed handheld electronic devices, in accordance with an embodiment of the present invention;

FIG. 4a illustrates a screenshot showing, by way of an example, a seamless infographic on a plurality of display units of adjacently placed plurality of handheld electronic devices, in accordance with a first exemplary embodiment of the present invention; and

FIG. 4b illustrates a screenshot showing, by way of an example, a seamless infographic on a plurality of display units of a plurality of adjacently placed handheld electronic devices, in accordance with a second exemplary embodiment of the present invention.

FIG. 5 illustrates a block diagram showing, by way of an example, a system configured to produce a seamless infographic display, in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF EMBODIMENTS

While this technology is illustrated and described in a preferred embodiment, a processor-implemented method for producing a seamless infographic on plurality of display units of adjacently placed plurality of handheld electronic devices may be produced in many different configurations, forms and computer languages. There is depicted in the drawings, and herein described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the technology described herein.

Reference will now be made in detail to several embodiments of the invention, which are illustrated in the accompanying drawings. Wherever feasible and convenient, the same reference numerals are used in the figures and the description to refer to the same or like parts. The drawings are in a simplified form and not to precise scale. For purposes of convenience and clarity only, directional terms, such as top, bottom, left, right, up, down, over, above, below, beneath, rear, and front may be used with respect to the accompanying drawings.

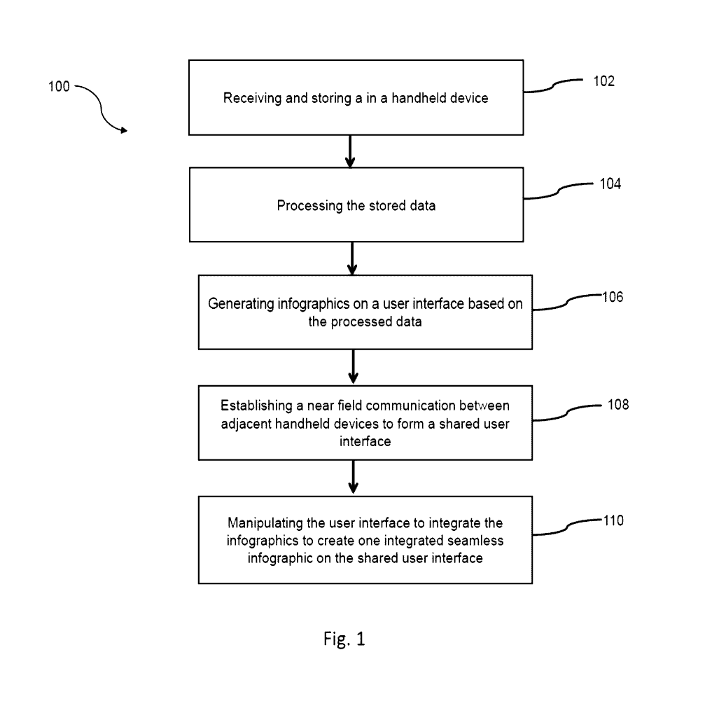

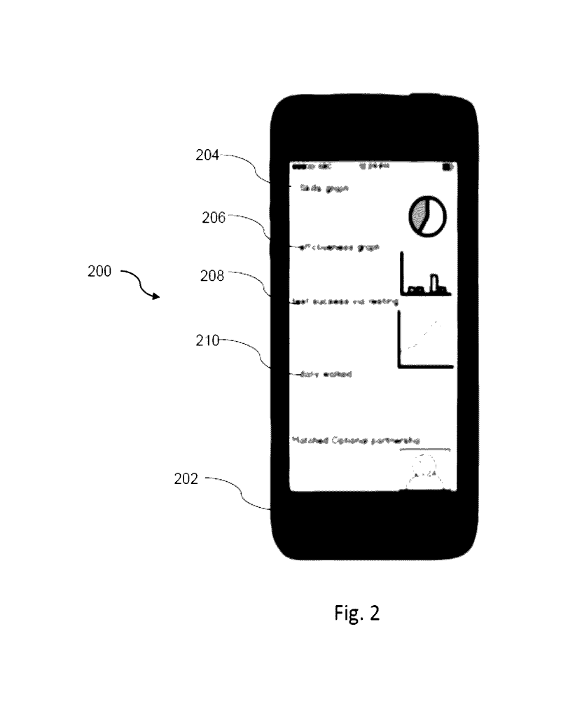

FIG. 1 illustrates a flowchart of a method 100 for producing a seamless infographic on a plurality of display units of a plurality of adjacently placed handheld electronic devices. The method 100 includes a step 102 of receiving and storing data, which can be associated with a user, in a handheld electronic device. In a preferred embodiment, the stored data is personal data of the user. Data can further relate to team strength, a digital personality of the user, etc. The digital personality is shown and explained in detail in conjunction with FIG. 2 of the present invention.

The method 100 includes a step 104 of processing at least a portion of the stored data from the handheld electronic device. In the preferred embodiment of the present invention, the handheld electronic devices are each a mobile phone, cell phone, iPhone, or smart phone. Examples of other types of handheld electronic devices include but are not limited to slate computers, such as tablet computers or tablet PCs, wearable computers, smartwatches, PDAs and other handheld devices that are equipped with Bluetooth and NFC capabilities that allow connections to other devices.

The method 100 includes a step 106 of generating at least a portion of the one or more infographics on a user interface based on at least the portion of the processed data. Infographics are known as data visualizations or information graphics. Infographics are graphical visual representations of information, data, or knowledge, intended to present complex information quickly and clearly. Infographic representations include one or more text elements and/or graphic elements.

The step 106 is then followed by a step 108 of establishing a near-field communication (NFC) in between adjacently placed plurality of handheld electronic devices to form a shared user interface. The NFC may be established via data tags. Examples of near field communication data tags include but are not necessarily limited to, tickets, information signs or placards, security passes, currency, or storage devices containing data formatted to a data tag specification. Examples of NFC protocols include but not limited to Wi-Fi or Bluetooth.

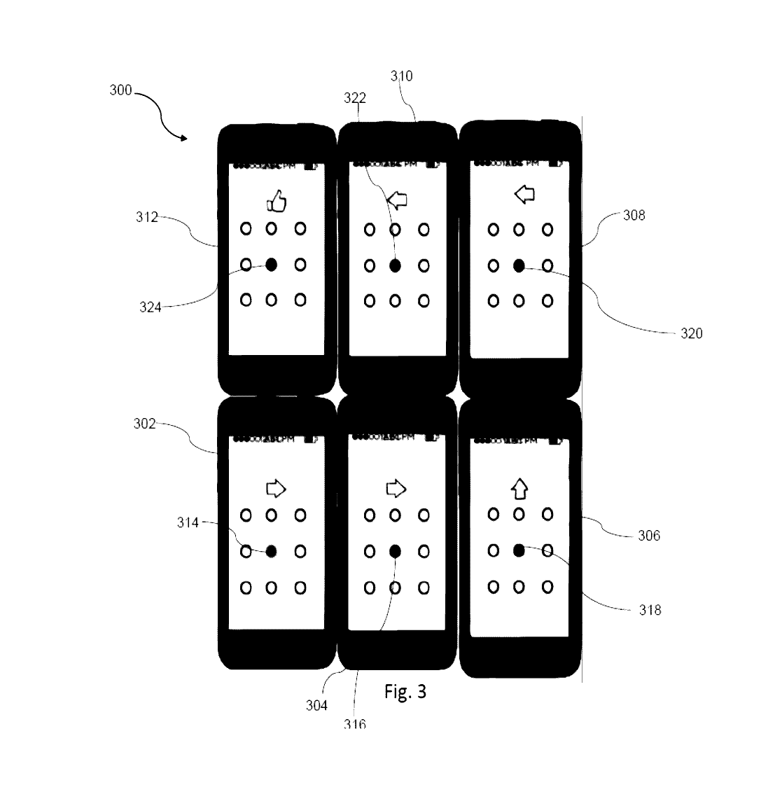

The step 108 is then followed by a step 110 of manipulating the user interface to integrate a portion of at least two infographics from at least two handheld electronic devices to create at least one integrated seamless infographic on the shared user interface. The manipulation of the infographics is explained in detail in conjunction with FIG. 3 of the present invention.

In another embodiment of the present invention the stored data is one or more instances of personal data in a handheld electronic device. For example personalities of a user can be inferred from basic information accessible from the user's handheld electronic device. Personal data analyzers may be used to collect the data from the user's handheld device.

FIG. 2 illustrates a screenshot 200 showing, by way of an example, a handheld electronic device 202 displaying a digital personality of a user, in accordance with an exemplary embodiment of the present invention. Examples of a digital personality include but are not limited to a skills graph 204, effectiveness graph 206, test success via running 208 and daily walked 210.

FIG. 3 illustrates a screenshot 300 showing, by way of an example, a swipe gesture for connecting the displays of a plurality of adjacently placed handheld electronic devices, in accordance with an embodiment of the present invention. In an exemplary embodiment of the present invention plurality of handheld electronic devices 302, 304, 306, 308, 310 and 312 are held adjacently. Each of the handheld electronic devices 302, 304, 306, 308, 310 and 312 present its user.

The manipulating of the user interface of the respective handheld electronic devices 302, 304, 306, 308, 310 and 312 may be based on, at least in part, a command, a movement, or a combination thereof associated with the plurality of handheld electronic devices 302, 304, 306, 308, 310 and 312. Further, the command may be a gesture and a positional adjustment captured by at least one of the handheld electronic device. The manipulation may be performed by moving fingers on the screen in the direction of the arrows.

In an exemplary embodiment the touch gesture is in form of a swipe by finger in direction of 314, 316, 318, 320, 322 and 324 along arrows which helps to connect adjacently placed plurality of handheld electronic devices 302, 304, 306, 308, 310 and 312. The touch gestures of handheld electronic devices 302, 304, 306, 308, 310 and 312 may recognize the clockwise circular motion in order to determine their order.

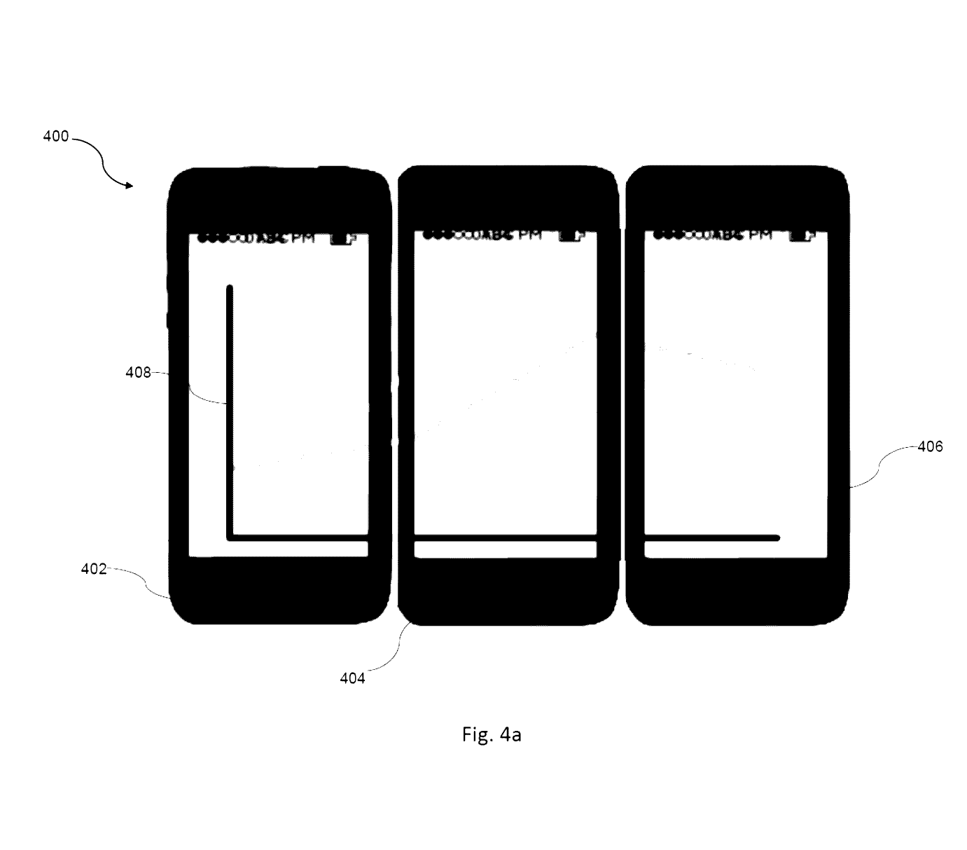

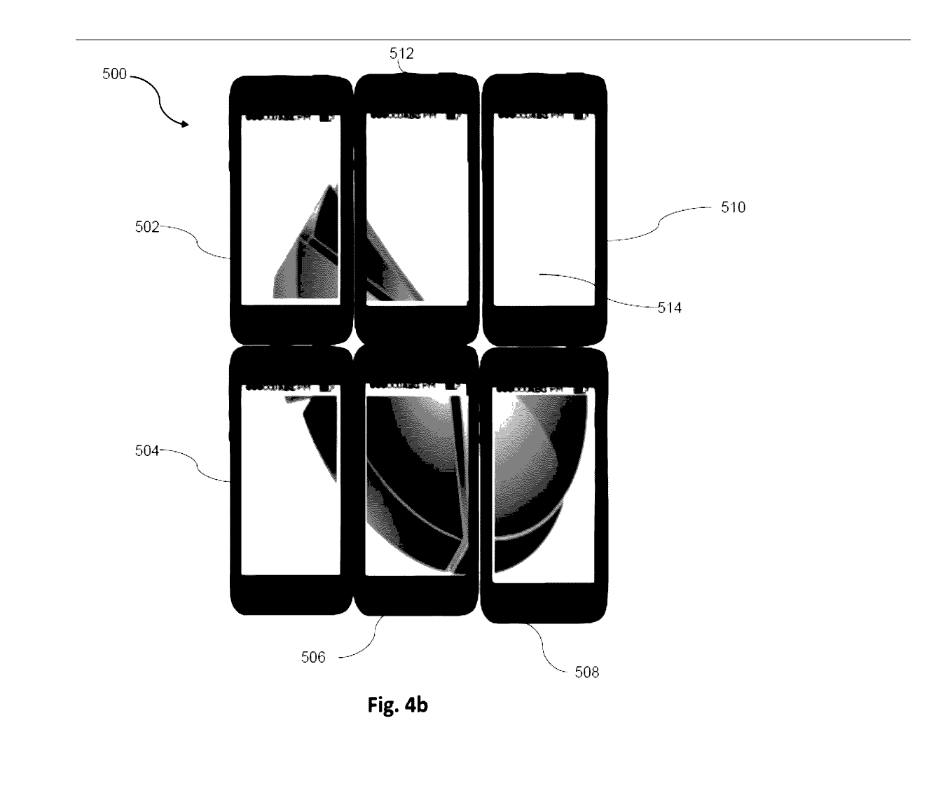

FIG. 4a and FIG. 4b illustrates a screenshot showing, by way of an example, seamless infographic on plurality of display units of adjacently placed plurality of handheld electronic devices, in accordance with a first exemplary embodiment and a second exemplary embodiment respectively.

FIG. 4a illustrates a screenshot 400 showing seamless infographic in form of a line graph 408 on plurality of display units of adjacently placed plurality of handheld electronic devices 402, 404 and 406. The plurality of adjacent handheld electronic devices 402, 404 and 406 forms a shared user interface by establishing a near-field communication. In an exemplary embodiment the data represented is collected from digital personalities of individual users of the handheld electronic devices 402, 404 and 406 to show team graphs that demonstrate the strengths and team skills together.

A user may move between the seamless infographic 408 by swiping all the display units of plurality of adjacent handheld electronic devices 402, 404 and 406. The seamless infographic 408 in form of team graphs may be in form of a line graph. The team graphs may be based on the personal graphs of users of the handheld electronic devices 402, 404 and 406. The type of graphs may vary according to requirements of the user.

FIG. 4b illustrates a screenshot 500 showing a seamless infographic in the form of a pie-chart 514 on a plurality of display units of a plurality of adjacent handheld electronic devices 502, 504, 506, 508, 510 and 512 as a second exemplary embodiment of the present invention.

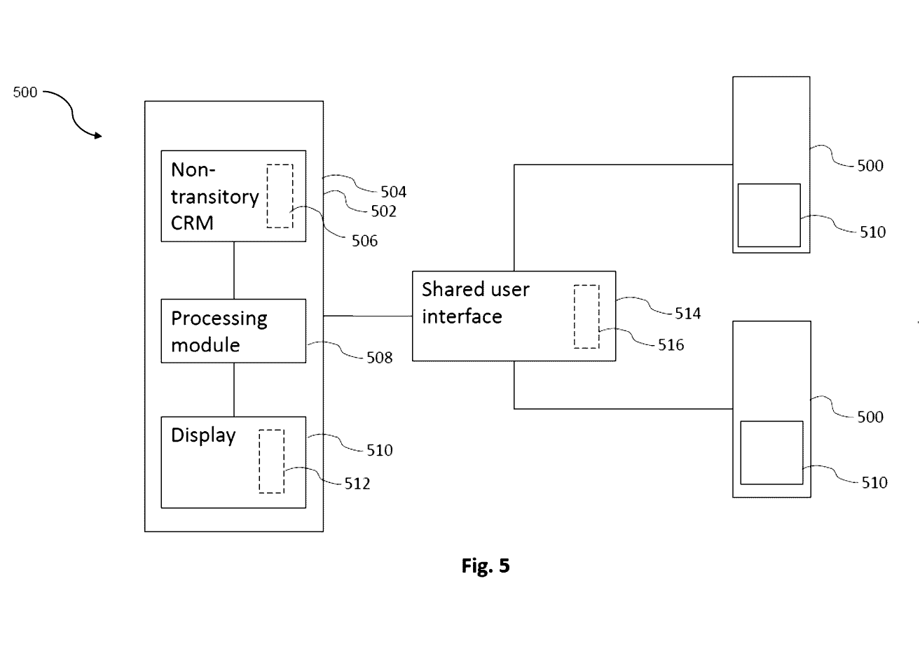

FIG. 5 illustrates a system configured to produce a seamless infographic display, according to an embodiment of the invention.

The system 500 includes at least two handheld electronic devices 502. Each handheld electronic device 502 has a display 510. Displays 510 may or may not be identical, and handheld electronic devices 502 may or may not contain other elements described herein.

At least one handheld electronic device 500 has a non-transitory computer readable medium (CRM) 502 configured to store data associated with a user. The non-transitory CRM can be volatile memory, non-volatile memory, a storage device, and the like.

At least one handheld electronic device 500 contains a processor 508. Processor 508 is configured to receive and process data 506.

Display 510 of least one handheld electronic device 500 contains a user interface 512. User interface 512 is configured to display at least a portion of data 506 as an infographic.

The handheld electronic devices 502 establish a near-field communication display a shared user interface 514. Near-field communication can be based on any combination of Wi-Fi, Bluetooth, and similar technologies. Near-field communication is used to establish a shared user interface between handheld electronic devices 502.

The user interface 512 is manipulable to integrate a portion of at least two infographics from at least two handheld electronic devices 502 to create at least one integrated seamless infographic 516 on shared user interface 514.

The infographics may be visualized in many sizes, shapes, and colors. Examples of the infographics may include but are not limited to index charts, stacked graphs, small multiples, horizon graphs, histograms, box-and-whisker plots which convey statistical features such as a mean, median, and outliers, maps, a force-directed layout, arc diagrams, personal information, and a matrix view.

The many features and advantages of the invention are apparent from the above description. It is apparent from the foregoing that a new and improved processor-implemented method for producing a seamless infographic on plurality of display units of plurality of adjacent handheld electronic devices has been provided. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

1. A processor-implemented method for producing a seamless infographic on a plurality of display units of a plurality of adjacent handheld electronic devices, the processor-implemented method comprising the steps of:
receiving and storing data associated with a user in a handheld electronic device;
processing at least a portion of the stored data from the handheld electronic device;
generating at least a portion of one or more infographics on a user interface based on at least a portion of the processed data;
establishing a near-field communication between a plurality of adjacent handheld electronic devices to form a shared user interface; and
manipulating the user interface to integrate a portion of at least two infographics from at least two handheld electronic devices to create at least one integrated seamless infographic on the shared user interface.

2. The method of claim 1, wherein manipulating the user interface is based on, at least in part, a command, a movement, or a combination thereof associated with the plurality of handheld electronic devices.

3. The method of claim 2, wherein the command is a gesture captured by at least one of the handheld electronic devices.

4. The method of claim 1, wherein the stored data is one or more of personal data, team strength, and a digital personality in the handheld electronic device.

5. The method of claim 4, wherein the stored data is a digital personality comprising one or more of a skills graph, effectiveness graph, test success via running, and daily walked.

6. The method of claim 1, wherein said at least one infographic includes one or more of text elements and graphic elements.

7. The method of claim 1, wherein said near field communication is established via data tags.

8. The method of claim 7, wherein said data tags are one or more of tickets, information signs or placards, security passes, currency, and storage devices containing data formatted to a data tag specification.

9. The method of claim 1, wherein a protocol of the near field communication is Wi-Fi, Bluetooth, or a combination of Wi-Fi and Bluetooth.

10. The method of claim 1, wherein said infographics seamless infographic are selected from one or more of index charts, stacked graphs, small multiples, horizon graphs, histograms, box-and-whisker plots, maps, a force-directed layout, arc diagrams, personal information, and a matrix view.

11. A processor-implemented system for producing a seamless infographic on a plurality of display units of a plurality of adjacent handheld electronic devices, comprising:
a plurality of adjacent handheld electronic devices, each said device containing a display;
at least one non-transitory computer readable medium, contained in at least one of said handheld electronic devices, configured to store data associated with a user;
at least one processor, contained in at least one of said handheld electronic devices, configured to receive and process said data;
at least one user interface contained on at least one of said displays, configured to display at least a portion of said data as an infographic;
a near-field communication between said plurality of handheld electronic devices, shared user interface contained on at least two of said displays, using said near-field communication,
wherein said at least user interface is further configured to be manipulable to integrate a portion of at least two infographics from at least least two handheld electronic devices to create at least one integrated seamless infographic on the shared user interface.

12. The system of claim 11, wherein said system is further configured to manipulate the user interface based on, at least in part, a command, a movement, or a combination thereof associated with the plurality of handheld electronic devices.

13. The system of claim 12, wherein the command is a gesture captured by at least one of the handheld electronic devices.

14. The system of claim 11, wherein the stored data is one or more of personal data, team strength, and a digital personality in the handheld electronic device.

15. The system of claim 14, wherein the stored data is a digital personality comprising one or more of a skills graph, effectiveness graph, test success via running, and daily walked.

16. The system of claim 11, wherein said at least one infographic includes one or more of text elements and graphic elements.

17. The system of claim 11, wherein said near field communication is established via data tags.

18. The system of claim 17, wherein said data tags are one or more of tickets, information signs or placards, security passes, currency, and storage devices containing data formatted to a data tag specification.

19. The system of claim 11, wherein a protocol of the near field communication is Wi-Fi, Bluetooth, or a combination of Wi-Fi and Bluetooth.

20. The system of claim 11, wherein said infographics and seamless infographic are selected from one or more of index charts, stacked graphs, small multiples, horizon graphs, histograms, box-and-whisker plots, maps, a force-directed layout, arc diagrams, personal information, and a matrix view.
